(19) United States
(12) Patent Application Publication
(10) Pub. No.: US 2025/0192480 A1
(43) Pub. Date: Jun. 12, 2025

(54) SOCKET ASSEMBLY AND ELECTRONIC APPARATUS

(71) Applicant: Anker Innovations Technology Co., Ltd., Changsha (CN)

(72) Inventors: Jinshi Lai, Shenzhen (CN); Yiyong Li, Shenzhen (CN)

(21) Appl. No.: 19/059,822

(22) Filed: Feb. 21, 2025

Related U.S. Application Data
(63) Continuation of application No. PCT/CN2023/114530, filed on Aug. 23, 2023.

(30) Foreign Application Priority Data
Aug. 25, 2022 (CN) 202211029007.7

(51) Int. Cl. H01R 13/641; H01R 13/66; H01R 24/78; H01R 103/00

(52) U.S. Cl. CPC H01R 13/641; H01R 13/6675; H01R 24/78; H01R 2103/00

(57) ABSTRACT

A socket assembly and an electronic apparatus are disclosed. The socket assembly comprises a socket body, a power supply electrode group, and a detection electrode assembly. The power supply electrode group is configured to contact a plug electrode group inserted into the socket body, and contacting the plug electrode group when the plug electrode group is further inserted to a preset position in the socket body. The detection electrode assembly is configured to detect the insertion state of the plug electrode group. When the plug electrode group is not inserted to the preset position, the detection electrode assembly is in the off state. When the plug electrode group is inserted to the preset position, the detection electrode assembly is in the on state to form a current loop. The socket assembly can effectively improve the use safety of a socket and effectively save energy.

### CROSS-REFERENCE TO RELATED APPLICATIONS

The present disclosure is a continuation of and claims priority to International Application No. PCT/CN2023/114530, filed on Aug. 23, 2023, which, in turn, claims priority to Chinese Patent Application No. 202211029007.7, filed on Aug. 25, 2022. The entire disclosure of each of the above applications are incorporated herein by reference.

### TECHNICAL FIELD

The present application relates to the technical field of safety electrical appliance sockets, in particular to a socket assembly and an electronic apparatus.

### BACKGROUND

Currently, existing sockets have significant safety risks during their usage. When a plug is inserted, a sudden surge of high current occurs, generating an instantaneous high voltage, which may lead to air breakdown and electrical discharge, causing sparks that increase the risk of fire, and resulting in safety hazards. When the socket is in a standby mode, if the user does not manually turn off the output of inverter current, the socket continues to output power. Users often forget to turn off the inverter current, leading to continuous power consumption, unnecessary energy waste and potential wear on the socket.

### SUMMARY

In order to solve the above problems, examples of the present application provide a socket assembly and an electronic apparatus. The socket assembly can address issues related to the sparking phenomenon generated at the moment of insertion of a plug, and can also turn off current output when a socket stands by to save energy with enhanced safety features.

In a first aspect, the examples of the present application provide a socket assembly. The socket assembly includes a socket body, a power supply electrode group, and a detection electrode assembly.

The power supply electrode group is disposed in the socket body and includes two power supply electrodes, and the two power supply electrodes are configured for contacting the plug electrode group inserted into the socket body, and contacting the plug electrode group when the plug electrode group is further inserted to a preset position in the socket body.

The detection electrode assembly is disposed in the socket body, and is configured for detecting the insertion state of the plug electrode group, wherein the detection electrode assembly has an off state and an on state; when the plug electrode group is not inserted to the preset position, the detection electrode assembly is in the off state; alternatively, when the plug electrode group is inserted to the preset position, the detection electrode assembly is in the on state to form a current loop.

In a second aspect, the examples of the present application provide an electronic apparatus. The electronic apparatus includes an apparatus body and a socket assembly.

The apparatus body includes an inverter circuit and a control circuit, the control circuit is electrically connected to the inverter circuit, and the inverter circuit is configured for being electrically connected to a power source;

The socket assembly as described above is disposed on the apparatus body, and the power supply electrode group is electrically connected to the inverter circuit. The detection electrode assembly is electrically connected to the control circuit.

The control circuit is configured for, when triggered by the detection electrode assembly, controlling the inverter circuit and supplying power to an outside or external environment through the power supply electrode group when the detection electrode assembly is in the on state, and controlling the inverter circuit to stop supplying power to the outside when the detection electrode assembly is in the off state.

Beneficial effects of the present application are as follows: Unlike the prior art, the power supply electrode group and the detection electrode assembly are provided on the socket assembly, where the detection electrode assembly detects the insertion state of the plug electrode group. When the plug electrode group is inserted to the preset position and contacts the power supply electrode group, the detection electrode assembly is in an on state, which can form a current loop and then generate a detection signal. The detection signal can be provided to the control circuit, and the control circuit controls the inverter circuit to supply power to the outside through the power supply electrode group. As such, the phenomenon of sparking at the moment of insertion of a plug can be effectively solved, and safety hazards of a socket during use can be reduced. Meanwhile, when the plug electrode group is not inserted to the preset position, the detection electrode assembly is in an off state without forming a current loop or generating a detection signal, and the control circuit controls the inverter circuit to stop supplying power to the outside, which can solve the problem that the standby socket continues to supply power, reduce unnecessary power consumption, and effectively save energy.

### BRIEF DESCRIPTION OF THE DRAWINGS

To describe the technical solutions in the examples of the present application more clearly, the following briefly introduces the accompanying drawings required for use in the description of the examples. Apparently, the accompanying drawings in the following description show only some examples of the present application, and those of ordinary skill in the art can further derive other drawings from the accompanying drawings without any creative effort. In the figures:

FIG. 1 is a schematic block diagram of a circuit structure of an electronic apparatus according to an example of the present application;

FIG. 2 is a schematic diagram of a three-dimensional structure of a socket assembly according to an example of the present application;

FIG. 3 is a schematic diagram of a cross-sectional structure of the socket assembly shown in FIG. 2 taken along line A-A;

FIG. 4 is a schematic diagram of an exploded structure of the socket assembly shown in FIG. 2;

FIG. 5 is a schematic diagram of a cross-sectional structure of the socket assembly shown in FIG. 2 taken along line B-B;

FIG. 6 is a schematic diagram of an exploded structure of the socket assembly according to another example of the present application;

FIG. 7 is a schematic diagram of another exploded structure of the socket assembly according to another example of the present application; and

FIG. 8 is a schematic diagram of a three-dimensional structure of the socket assembly according to another example of the present application.

### DETAILED DESCRIPTION

In order to make the above objectives, features, and advantages of the present application more obvious and understandable, specific examples of the present application will be described in detail below in conjunction with the accompanying drawings. It can be understood that the specific examples described here are only used for explaining the present application, rather than limiting the present application. It should also be noted that, for the convenience of description, only the portions related to the present application, not all structures, are shown in the accompanying drawings. All other examples obtained by a person of ordinary skill in the art mounting based on the examples of the present application without creative efforts shall fall within the protection scope of the present application.

The terms “first”, “second”, etc. in the present application are used for distinguishing different objects, not for describing a specific order. In addition, the term “include” and “provided with” and any variant thereof are intended to cover a non-exclusive inclusion. For example, a process, method, system, product, or device that includes a series of steps or units is not limited to the listed steps or units, but further includes unlisted steps or units, or further includes other inherent steps or units of the process, method, product, or device.

The phrase “example” referred to herein means that specific features, structures, or characteristics described in conjunction with the example may be included in at least one example of the present application. The phrase appearing at various places in the description does not necessarily refer to the same example, or an independent or alternative example exclusive of other examples. Those skilled in the art understand explicitly and implicitly that an example described herein may be combined with another example.

An electronic apparatus 1 may be an energy storage apparatus, a plug board, or various electrical appliances with sockets. The energy storage apparatus may be, for example, a portable power source.

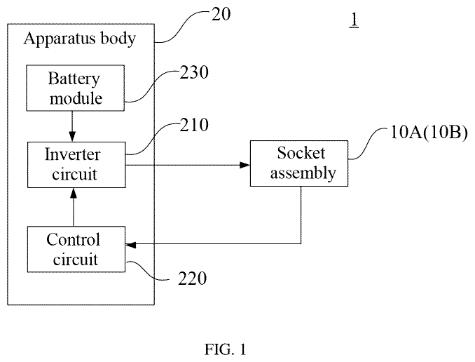

As shown in FIG. 1, the electronic apparatus 1 may include a socket assembly 10A (10B) and an apparatus body 20. The socket assembly 10A (10B) is disposed on the apparatus body 20.

The apparatus body 20 may include an inverter circuit 210 and a control circuit 220. The control circuit 220 is electrically connected to the inverter circuit 210, and the inverter circuit 210 is configured for being electrically connected to a power source. The apparatus body 20 may further include a battery module 230, and the battery module 230 is electrically connected to the inverter circuit 210.

The inverter circuit 210 is configured for converting direct current into alternating current. Specifically, the inverter circuit 210, when turned on, can convert direct current output by the battery module 230 into alternating current, and the socket assembly 10 outputs the alternating current to the outside. The inverter circuit 210 may be an existing inverter or the like.

The control circuit 220 can be configured for controlling the operation of the electronic apparatus 1, for example, the control circuit 220 can control the inverter circuit 210 to turn on or off. The inverter circuit 210 can supply power to the outside through the socket assembly 10A (10B) when turned on, and stop supplying power to the outside when turned off.

The control circuit 220 may be a central processing unit (CPU). The control circuit 220c may be an integrated circuit chip, with signal processing capability. The control circuit 220 may alternatively be a general-purpose processor, a digital signal processor (DSP), an application specific integrated circuit (ASIC), an image signal processor (ISP), a field programmable gate array (FPGA), or other programmable logic devices, discrete gates or transistor logic devices, or discrete hardware components. The general-purpose processor may be a micro control unit (MCU), a single chip micyoco (SCM), or the control circuit 220 may alternatively be any conventional processing circuit/processor, or other circuit at least capable of controlling the inverter circuit 210 to turn on or off.

The battery module 230 can store electrical energy and serve as a power source. The battery module 230 can provide the electrical energy to the outside through the inverter circuit 210.

The socket assembly 10A (10B) is electrically connected to the inverter circuit 210 and the control circuit 220, respectively. The socket assembly 10 is configured for inserting a plug 3 of an electrical device. When a plug electrode group 30 of the plug 3 is inserted to a preset position of the socket assembly 10A (10B), a current loop is formed between the socket assembly 10 and the control circuit 220, a detection signal can be generated, the control circuit 220 can control the inverter circuit 210 to turn on mounting based on the detection signal, and then the inverter circuit 210 outputs electrical energy to the socket assembly 10A (10B). When the plug electrode group 30 of the plug 3 is not inserted to the preset position of the socket assembly 10, no current loop is formed between the socket assembly 10A (10B) and the control circuit 220, no detection signal is generated, and the control circuit 220 controls the inverter circuit 210 to turn off or remain off. The detection signal is, for example, a current signal or a level signal.

The socket assemblies 10A and 10B to be described below may be used as two examples, the same content between the two may be referenced to each other, and different content may also be combined with each other.

Firstly, the socket assembly 10A may refer to the following description:

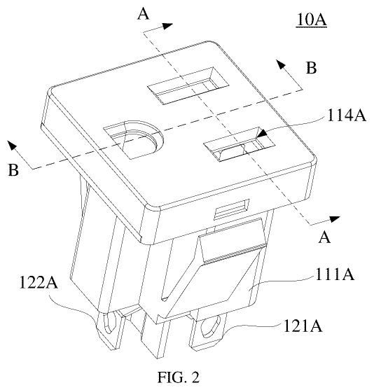

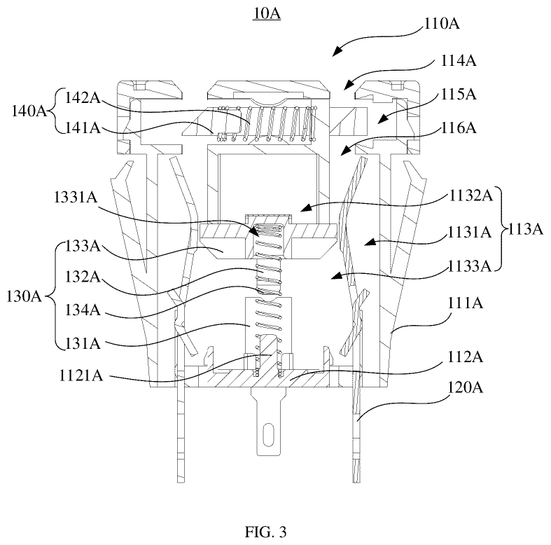

As shown in FIG. 2 and FIG. 3, the socket assembly 10A may include a socket body 110A, a power supply electrode group 120A, a detection electrode assembly 130A, and a protective door mechanism (e.g., a protective door) 140A.

The power supply electrode group 120A is disposed in the socket body 110A. The detection electrode assembly 130A is disposed in the socket body 110A. The protective door mechanism is disposed in the socket body 110A. The plug electrode group 30 of the plug 3 may be inserted into the socket body 110A, and contact the power supply electrode group 120A. The detection electrode assembly 130A may be configured for detecting the insertion state of the plug electrode group 30. The protective door mechanism 140A is configured for shielding the power supply electrode group 120A when the plug electrode group 30 of the plug 3 is not inserted into the socket body 110A, and can expose the power supply electrode group 120A when the plug electrode group 30 of the plug 3 is inserted into the socket body 110A, such that the plug electrode group 30 can contact the power supply electrode group 120A, thereby improving the concealment of the power supply electrode group 120A and enhancing safety performance.

When the plug electrode group 30 is inserted into the socket body 110A, the power supply electrode group 120A can contact the plug electrode group 30 inserted into the socket body 110A and can transmit current to the plug electrode group 30. When the plug electrode group 30 contacts the power supply electrode group 120A and is further inserted into the socket body 110A, the power supply electrode group 120A contacts the plug electrode group 30. The detection electrode assembly 130A has an off state and an on state; when the plug electrode group 30 is not inserted to the preset position, the detection electrode assembly 130A is in the off state; when the plug electrode group 30 is inserted to the preset position, the detection electrode assembly 130A is in the on state to form a current loop.

Specifically, in the electronic apparatus 1, the power supply electrode group 120A may be electrically connected to the inverter circuit 210. The detection electrode assembly 130A may be electrically connected to the control circuit 220. The control circuit 220 is configured for, triggered by the detection electrode assembly 130A, controlling the inverter circuit 210 and supplying power to the outside through the power supply electrode group 120A when the detection electrode assembly 130A is in the on state, and controlling the inverter circuit 210 to stop supplying power to the outside when the detection electrode assembly 130A is in the off state.

In this example, the detection electrode assembly 130A is disposed in the socket assembly 10, to detect the insertion of the plug electrode group 30 during use; when the plug electrode group 30 is inserted into the socket body to contact the power supply electrode group 120A, and further inserted to the preset position while maintaining contact with the power supply electrode group 120A, the detection electrode assembly 130A is in the on state to form a current loop and transmit detection signals to the control circuit 220 of the apparatus body 20, such that the control circuit 220 of the apparatus body 20 controls the inverter circuit 210 to transmit inverter current to the socket assembly 10, thereby avoiding the phenomenon of sparking at the moment of contact of the plug electrode group 30 with the power supply electrode group 120A, and improving the safety of the socket. Meanwhile, when the plug electrode group 30 is not inserted to the preset position, the detection electrode assembly 130A is in the off state without forming a current loop or generating a detection signal, and the control circuit 220 controls the inverter circuit 210 to stop supplying power to the outside, which can solve the problem that the standby socket still supplies power, reduce unnecessary power consumption, and effectively save energy.

As shown in FIG. 2 and FIG. 3, the socket body 110A may include a mounting base 111A and a bottom plate 112A. The mounting base 111A is connected to the bottom plate 112A.

The socket body 110A is provided with an insertion space 113A and an insertion hole 114A, where the insertion hole is in communication with the insertion space. The socket body 110A is further provided with a spacing chamber 115A and a communication hole 116A, the spacing chamber is spaced apart from the insertion space 113A, the communication hole is in communication with the spacing chamber 115A, and the spacing chamber 115A is in communication with the insertion hole 114A.

Specifically, the insertion hole 114A and the insertion space 113A are formed on the mounting base 111A. The bottom plate 112A is disposed at the bottom of the mounting base 111A away from the insertion hole 114A. The insertion space 113A is formed inside the mounting base 111A. The insertion hole 114A is formed at a top of the mounting base 111A, and may be in communication with the insertion space 113A.

Specifically, the spacing chamber 115A is disposed in the mounting base 111A, located between the insertion space 113A and the insertion hole 114A, and spaced apart from the insertion space 113A. The communication hole 116A connects the spacing chamber 115A with the insertion space 113A, and is opposite to the insertion hole 114A. There are two insertion holes 114A and two communication holes 116A, and they correspond one to one.

The power supply electrode group 120A and the detection electrode assembly 130A are both disposed inside the mounting base 111A, and the power supply electrode group 120A is inserted into the mounting base 111A and extends out of the bottom plate 112A. The insertion holes 114A can allow at least portions of the plug electrodes of the plug electrode group 30 to be inserted into the mounting base 111A, and then the plug electrodes are in contact with the power supply electrode group 120A and trigger the detection electrode assembly 130A. The detection electrode assembly 130A may be inserted into the bottom plate 112A and extend out of the bottom plate 112A.

The insertion space 113A is configured for accommodating the power supply electrode group 120A and the detection electrode assembly 130A. The plug electrode group 30 can enter the insertion space 113A, and in the insertion space 113A, contact the power supply electrode group 120A and trigger the detection electrode assembly 130A.

Specifically, the insertion space 113A may include two first insertion chambers 1131A, a second insertion chamber 1132A, and a sliding hole 1133A. The second insertion chamber 1132A is disposed between the two first insertion chambers 1131A. The two first insertion chambers 1131A can accommodate the power supply electrode group 120A, and the second insertion chamber 1132A can accommodate the detection electrode assembly 130A. The sliding hole 1133A connects the two first insertion chambers 1131A and the second insertion chamber 1132A.

The extension direction of the sliding hole 1133A is consistent with the insertion direction of the first insertion chambers 1131A.

The plug electrode group 30 includes at least two plug electrodes 310. The two plug electrodes 310 are inserted from the two insertion holes 114A or removed from the two first insertion chambers 1131A in the insertion direction. In another example, the quantity of the first insertion chambers 1131A may be three or four, which is not limited here.

The insertion holes 114A are in the same quantity as and correspond one to one with the plug electrodes 310 and the first insertion chambers 1131A in the insertion space 113A, and are configured for accommodating the plug electrode group 30 to pass through the top of the mounting base 111A and enter the first insertion chambers 1131A. The quantity of the insertion holes 114A may be two, three, or four, which is not limited here.

The insertion hole 114A is further from the insertion space 113A than the spacing chamber 115A, and the spacing chamber 115A is configured for accommodating the protective door mechanism 140A. The communication holes 116A, the insertion holes 114A, and the first insertion chambers 1131A are in the same quantity and in one-to-one correspondence, and are provided for the plug electrodes 310 to pass through and enter the first insertion chambers 1131A.

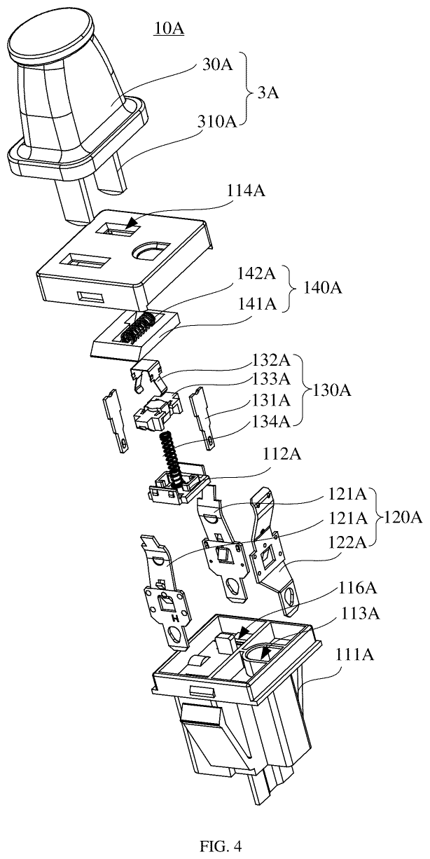

As shown in FIG. 3 and FIG. 4, the power supply electrode group 120A may include two power supply electrodes 121A. The two power supply electrodes 121A are configured for contacting the plug electrode group 30 inserted into the socket body 110A, and maintaining the contact with the plug electrode group 30 in the process that the plug electrode group 30 is further inserted to the preset position in the socket body 110A.

The power supply electrode group 120A may further include a ground electrode 122A, which is spaced apart from the two power supply electrodes 121A. The two power supply electrodes 121A may be connected to a live wire and a neutral line respectively, and the ground electrode 122A is connected to a ground wire. The quantity of the plug electrodes 310 inserted into the socket assembly 10 may be three, where one plug electrode 310 contacts the ground electrode 122A and is connected to the ground wire by the ground electrode 122A.

The two power supply electrodes 121A are spaced apart and opposite to each other. The two power supply electrodes 121 extend from the outside of the socket body 110A to the insertion space 113A, and are disposed opposite to the two insertion holes 114A one to one. For example, the two power supply electrodes 121 are arranged to align one-to-one with the two insertion holes 114A. Specifically, the two power supply electrodes 121A pass through the bottom of the mounting base 111A and extend to the insertion space 113A. Further, the two power supply electrodes 121A extend into the two first insertion chambers 1131A in one-to-one correspondence, and are disposed opposite to the two insertion holes 114A one to one. The spaced first insertion chambers 1131A enable the two power supply electrodes 121A to isolate from each other without being easily short-circuited. Moreover, the first insertion chambers 1131A can also reduce the possibility of short circuits caused by the contact of the power supply electrodes 121A therein with other electrical components.

Specifically, one ends of the two power supply electrodes 121A may be in contact with the two plug electrodes 310. Specifically, the two plug electrodes 310 can contact one ends of the two power supply electrodes 121A when inserted into the first insertion chambers 1131A and maintain the contact with the two power supply electrodes 121A when further inserted to the preset position. The other ends of the two power supply electrodes 121A extending out of the socket body 110A may be connected to the inverter circuit 210. When the two power supply electrodes 121A contact the two plug electrodes 310, the inverter circuit 210 may transmit inverter current to the plug electrodes 310 through the two power supply electrodes 121A.

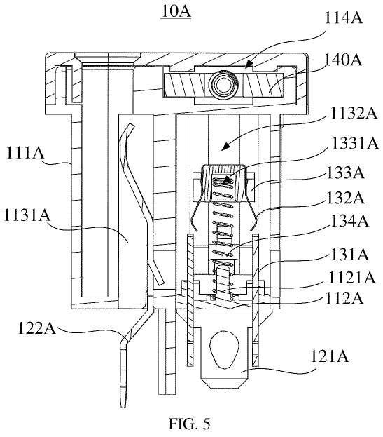

As shown in FIG. 4 and FIG. 5, the detection electrode assembly 130A may include two fixed electrodes 131A, a movable electrode 132A, a movable block 133A, and an elastic member 134A.

The two fixed electrodes 131A are disposed on the mounting base 110A at interval. The movable block 133A is movably disposed in the socket body 110A. The movable electrode 132A is fixedly connected to the movable block 133A, so enabling the moveable electrode 132A to move together with the movable block 133A. The elastic member 134A is disposed in the socket body 110A and connects the socket body 110A and the movable block 133A. The elastic member 134A can be configured for resetting the movable block 133A.

The two fixed electrodes 131A are disposed opposite and spaced apart. Specifically, the two fixed electrodes 131A extend from the outside of the socket body 110A to the insertion space 113A. Further, the two fixed electrodes 131A pass through the bottom plate 112A and extend to the insertion space 113A, respectively. Specifically, the two fixed electrodes 131A are disposed in the second insertion chamber 1132A, that is, the two fixed electrodes 131A pass through the bottom plate 112A and extend into the second insertion chamber 1132A. The arrangement direction of the two fixed electrodes 131A is perpendicular to the arrangement direction of the two power supply electrodes 121A, such that the fixed electrodes 131A and the power supply electrodes 121A do not contact or interfere with each other in their arrangement directions, which can effectively avoid short circuits between the excessively adjacent fixed electrodes 131A and power supply electrodes 121A in the same arrangement direction, thereby improving electrical reliability.

One ends of the two fixed electrodes 131A are located in the second insertion chamber 1132A and may be in contact with the movable electrode 132A, and the other ends outside the socket body 110A are connected to the control circuit 220 of the apparatus body 20 and may transmit signals to the control circuit 220.

The movable electrode 132A is movably disposed in the socket body 110A. The movable electrode 132A is fixedly connected to the movable block 133A. Specifically, a portion of the movable electrode 132A may be wrapped on a partial periphery of the movable block 133A and spaced opposite to the two fixed electrodes 131A. For example, the movable electrode 132A may be bent to form two movable electrode portions, which correspond one to one with the two fixed electrodes 131A.

Specifically, the movable electrode 132A separates from the two fixed electrodes 131A when the plug electrode group 30 is not inserted to the preset position, such that the detection electrode assembly 130A is in an off state. The movable electrode 132A contacts the two fixed electrodes 131A when the plug electrode group 30 is inserted to the preset position, to connect the two fixed electrodes 131A, such that the detection electrode assembly 130A is in an on state.

Specifically, the movable block 133A is disposed in the second insertion chamber 1132A in a sliding manner. That is, the movable electrode 132A is movable with the movable block 133A in the second insertion chamber 1132A. Specifically, a portion of the movable block 133A may extend from the sliding hole 1133A in the second insertion chamber 1132A to the first insertion chamber 1131A, enabling the portion of the movable block 133A to abut against the two plug electrodes 310 when the plug electrodes 310 of the plug electrode group 30 are inserted into the two first insertion chambers 1131A, and to be able to move in the second insertion chamber 1132A with the insertion of the plug electrodes 310. For example, two ends or two sides of the movable block 133A facing the first insertion chambers 1131A may extend to the two first insertion chambers 1131A from the sliding hole 1133A in communication with the two first insertion chambers 1131A respectively, enabling it to be abutted against by the two plug electrodes 310 and pushed by the plug electrodes 310.

Specifically, the plug electrodes 310 of the plug electrode group 30, when inserted into the two first insertion chambers 1131A, abut against the top of the movable block 133A (namely, the top of the movable block 133A facing the insertion hole 114A), and the movable block 133A can move in the second insertion chamber 1132A and the sliding hole 1133A under the drive of the two plug electrodes 310 of the plug electrode group 30, such that the movable electrode 132A fixedly connected to the movable block 133A contacts the two fixed electrodes 131A when the plug electrode group 30 is inserted to the preset position.

The movable block 133A is movably disposed in the socket body 110A, to drive the movable electrode 132A to contact the fixed electrodes 131A. The movable electrode 132A is fixedly connected to the movable block 133A, such that the movement of the movable electrode 132A can be effectively supported and be stable. By fixing the movable block 133A, the movable electrode 132A is less likely to shake or shift when contacting the two fixed electrodes 131A.

Further, the sliding hole 1133A is provided to connect the first insertion chambers 1131A and the second insertion chamber 1132A, and a portion of the movable block 133A extends from the sliding hole 1133A into the first insertion chambers 1131A, thereby limiting the movement of the movable block 133A in the extension direction of the sliding hole 1133A, making the movement of the movable block 133A more stable and standardized, and enhancing the stability and reliability of the structure.

The elastic member 134A is disposed in the insertion space 113A. Specifically, the elastic member 134A is disposed in the second insertion chamber 1132A and connected between the movable block 133A and the bottom plate 112A. The elastic member 134A has an initial state and an elastic compression state. When the movable block 133A is not pushed, the elastic member 134A is in the initial state. When the movable electrode 132A contacts the two fixed electrodes 131A, the elastic member 134A is in the elastic compression state.

Specifically, a support column 1121 extending to the second insertion chamber 1132A is provided on the side of the bottom plate 112A facing the second insertion chamber 1132A, an accommodating groove 1331 is formed on the side of the movable block facing the bottom plate 112A, one end of the elastic member 134A is inserted into the accommodating groove 1331 and abuts against the movable block 133A, and the other end is sleeved outside the support column 1121 and abuts against the bottom plate 112A.

In this example, the elastic member 134A further configured to connect the socket body 110A and the movable block 133A, can generate elastic compression after the plug electrode group 30 is inserted, and can drive the movable block 133A and the movable electrode 132A to automatically reset after the plug electrode group 30 is removed, making it more convenient.

The movable block 133A, when pushed by the plug electrode 310, can move towards the bottom plate 112A. When the plug electrode group 30 is inserted into the socket body 110A to push the movable block 133A to move, the elastic member 134A is compressed with the movement of the movable block 133A. Until the movable electrode 132A contacts the two fixed electrodes 131A, the elastic member 134A is in the elastic compression state. When the plug electrode group 30 is not inserted into the socket body 110A, the elastic member 134A resets the movable block 133A, such that the movable electrode 132A on the movable block 133A separates from the two fixed electrodes 131A until the elastic member 134A restores to the initial state. For example, the elastic member 134A may be a spring. Alternatively, the elastic member 134A may be other existing elastic bodies or elastic components, without limitation here.

Specifically, when the plug electrode group 30 is inserted into the insertion chamber 113 from the insertion hole 114A, the plug electrodes 310 abut against the first insertion chambers 1131A and extend to the top of the movable block 133A in the first insertion chambers 1131A, the plug electrodes 310 continue to push and drive the movable block 133A to move in the first insertion chambers 1131A and the sliding hole 1133A, the movable block compresses the elastic member 134A, and the two plug electrodes 310 contact the two power supply electrodes 121A in the two first insertion chambers 1131A, respectively. When the two plug electrodes 310 further move to the preset position, the movable electrode 132A contacts the two fixed electrodes 131A. At this time, the plug electrodes 310 remain in contact with the two power supply electrodes 121A, the elastic member 134A is in the elastic compression state, the movable electrode 132A connects the two fixed electrodes 131A, and the detection electrode assembly 130A is in the on state to form a current loop and generate detection signals. The detection signals generated by the detection electrode assembly 130A are transmitted to the control circuit 220 by the two fixed electrodes 131A, such that the control circuit 220 controls the inverter circuit 210 to open and supply electrical energy to the two power supply electrodes 121A. When the plug electrode group 30 is not inserted or removed from the preset position, the elastic member 134A resets the movable block 133A, and the elastic member 134A elastically presses against the movable block 133A, thereby driving the movable electrode 132A to separate from the two fixed electrodes 131A. At this time, the current loop is disconnected, the detection electrode assembly 130A is in the off state, and the detection electrode assembly 130A cannot transmit any detection signal to the control circuit 220.

By configuring the detection electrode assembly 130A, detection signals can be transmitted to the control circuit 220 after the plug electrodes 310 first contact the power supply electrodes 121A, and then the control circuit 220 controls the inverter circuit 210 to supply electrical energy to the power supply electrodes 121A, thereby avoiding the phenomenon of sparking due to changes in voltage and current at the moment when the plug electrode 310 contact the power supply electrodes 121A. Similarly, when the plug electrodes 310 are removed from the preset position but still contact the power supply electrodes 121A, the control circuit 220 controls the inverter circuit 210 to close to stop the power supply, such that the power supply electrodes 121A are not charged while still in contact with the plug electrodes 310, which can avoid sparks due to changes in the voltage circuit at the moment when the plug electrodes 310 separate from the charged power supply electrodes 121A.

As shown in FIG. 3, the protective door mechanism 140A is movably disposed in the spacing chamber 115A. The protective door mechanism 140A includes a shielding member 141A and a reset elastic member 142A. The shielding member 141A is provided with a wedge-shaped portion or section inclined towards a direction perpendicular to the communication hole 116A. The wedge-shaped portion or section of the shielding member 141A can shield or expose the communication hole 116A and the power supply electrode group 120A in the insertion space 113A. The reset elastic member 142A is disposed in the middle of the shielding member 141A.

Specifically, the protective door mechanism 140A is movable between a first position and a second position, to shield the communication hole 116A in the first position and expose the communication hole 116A in the second position. The plug electrodes 310, when inserted into the spacing chamber 115A, first press against the wedge-shaped portion or section of the shielding member 141A. When the plug electrodes 310 are pushed forward, the shielding member 141A is pushed from the first position to the second position through the wedge-shaped portion or section, and the elastic member 142A is stretched by the shielding member 141A. The shielding member 141A, when reaching the second position, exposes the communication hole 116A and the power supply electrode group 120A in the insertion space 113A, and the plug electrodes 310 enter the insertion space 113A. When the plug electrodes 310 are pulled out of the spacing chamber 115A, the elastic member 142A resets the shielding member 141A, the shielding member 141A returns from the second position to the first position, and the wedge-shaped portion or section of the shielding member 141A re-shields the communication hole 116A and the power supply electrode group 120A in the insertion space 113A.

Such settings can prevent water droplets or other conductive articles from falling onto the socket assembly 10 when not in use to short-circuit the socket assembly 10, improve the concealment of the power supply electrode group 120A, and enhance safety performance.

Based on the above content, a description of the specific mating process between the socket assembly 10 and the plug 3 is provided below:

When the plug electrode group 30 is inserted into the electronic apparatus 1 described in the present application, the plug electrodes 310 of the plug electrode group 30 first pass through the insertion holes 114A and press against the wedge-shaped portion or section of the shielding member 141A in the protective door mechanism 140A in the spacing chamber 115A, the plug electrodes 310 push the shielding member 141A from the first position to the second position through the wedge-shaped portion or section, to expose the communication hole 116A and the power supply electrode group 120A in the insertion space 113A, and the elastic member 142A is stretched by the shielding member 141A. The plug electrodes 310 of the plug electrode group 30 pass through the communication hole 116A and enter the insertion space 113A, and the plug electrodes 310 first contact the power supply electrodes 121A in the first insertion chambers 1131A of the insertion space 113A. The plug electrodes 310 press against the top of the movable block 133A in the detection electrode assembly 130A, the plug electrodes 310 push the movable block 133A and drives the movable electrode 132A on the movable block 133A to move in the first insertion chambers 1131A, and the elastic member 134A is compressed. When the plug electrodes 310 reach the preset position, the movable electrode 132A comes into contact with the two fixed electrodes 131A, the movable electrode 132A connects the two fixed electrodes 131A, the detection electrode assembly 130A is in the on state to form a current loop, and detection signals generated by the detection electrode assembly 130A are transmitted to the control circuit 220 in the apparatus body 20 by the two fixed electrodes 131A. The control circuit 220 controls the inverter circuit 210 to output inverter current to the power supply electrodes 121A of the power supply electrode group 120A, and the power supply electrodes 121A transmit the inverter current to the plug electrode group 30.

When the plug electrode group 30 is pulled out of the electronic apparatus 1 described in the present application, the plug electrodes 310 of the plug electrode group 30 first separate from the movable block 133A of the detection electrode assembly 130A, the elastic member 134A in the detection electrode assembly 130A resets the movable block 133A, and the movable electrode 132A on the movable block 133A separates from the two fixed electrodes 131A. At this time, the current loop is disconnected, the detection electrode assembly 130A is in the off state, the detection electrode assembly 130A cannot transmit any detection signal to the control circuit 220, and the control circuit 220 controls the inverter circuit 210 to stop outputting inverter current to the power supply electrodes 121A. After the power supply electrodes 121A stop outputting inverter current, the plug electrodes 310 separate from the power supply electrodes 121A, the insertion space 113A, and the spacing chamber 115A and leave the socket assembly 10 from the insertion hole 114A, and the wedge-shaped portion or section of the shielding member 141A in the protective door mechanism 140A is reset by the elastic member 142A, to re-shield the communication hole 116A and the power supply electrode group 120A in the insertion space 113A.

Secondly, the socket assembly 10B may refer to the following description:

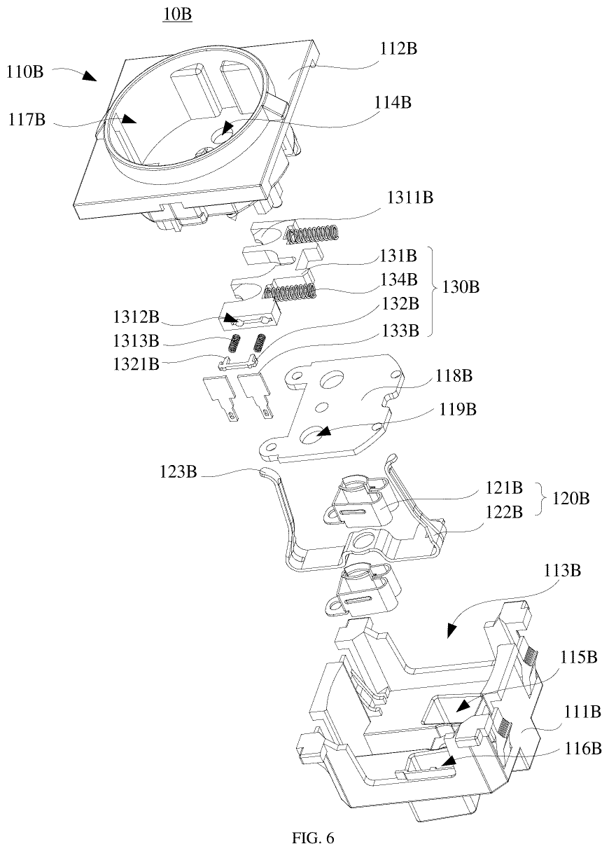

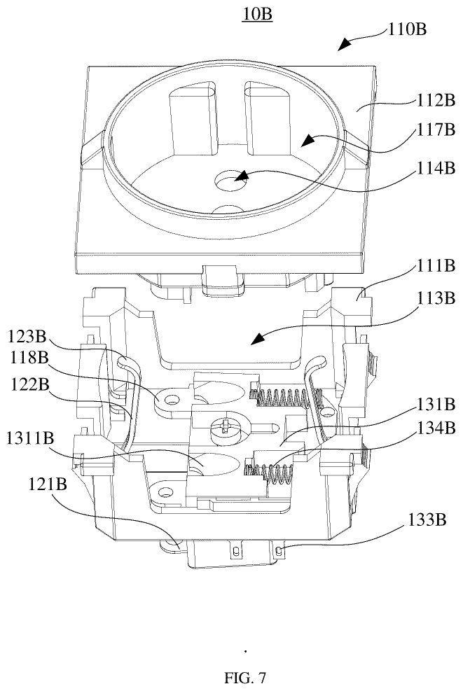

As shown in FIG. 6 and FIG. 7, the socket assembly 10B may include a socket body 110B, a power supply electrode group 120B, and a detection electrode assembly 130B.

The power supply electrode group 120B is disposed in the socket body 110B. The detection electrode assembly 130B is disposed in the socket body 110B. The plug electrode group 30 of the plug 3 may be inserted into the socket body 110B and contact the power supply electrode group 120B. The detection electrode assembly 130B may be configured for detecting the insertion state of the plug electrode group 30.

When the plug electrode group 30 is inserted into the socket body 110B, the power supply electrode group 120B can contact the plug electrode group 30 inserted into the socket body 110B and can transmit current to the plug electrode group 30. The detection electrode assembly 130B has an off state and an on state. When the plug electrode group 30 is not inserted to the preset position, the detection electrode assembly 130B is in the off state. When the plug electrode group 30 is inserted to the preset position, the detection electrode assembly 130B is in the on state to form a current loop.

Specifically, in the electronic apparatus 1, the power supply electrode group 120B may be electrically connected to the inverter circuit 210. The detection electrode assembly 130B may be electrically connected to the control circuit 220. The control circuit 220 is configured for, triggered by the detection electrode assembly 130B, controlling the inverter circuit 210 and supplying power to the outside through the power supply electrode group 120B when the detection electrode assembly 130B is in the on state, and controlling the inverter circuit 210 to stop supplying power to the outside when the detection electrode assembly 130B is in the off state.

In this example, the detection electrode assembly 130B is disposed in the socket assembly 10, to detect the insertion of the plug electrode group 30 during use; when the plug electrode group 30 is inserted to the preset position of the socket body 110B, the detection electrode assembly 130B is in the on state to form a current loop and transmit detection signals to the control circuit 220 of the apparatus body 20; the plug electrode group 30 is further inserted into the socket body 110B and contacts the power supply electrode group 120 B, and the control circuit 220 of the apparatus body 20 controls the inverter circuit 210 to transmit inverter current to the socket assembly 10. When the plug electrode group 30 is not inserted to the preset position, the detection electrode assembly 130B is in the off state without forming a current loop or generating a detection signal, and the control circuit 220 controls the inverter circuit 210 to stop supplying power to the outside, which can solve the problem that the standby socket still supplies power, reduce unnecessary power consumption, effectively save energy, and improve the safety of the socket.

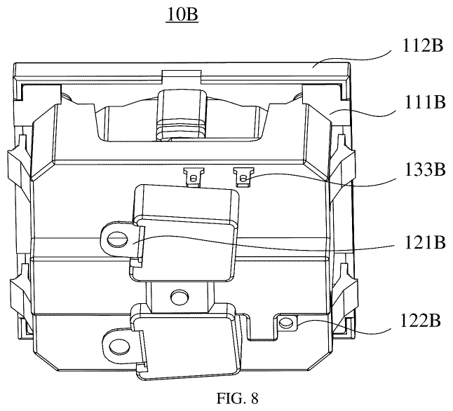

As shown in FIG. 6 to FIG. 8, the socket body 110B may include a mounting base 111B and a cover 112B. The mounting base 111B is connected to the cover 112B.

The socket body 110B is provided with an insertion space 113B and two insertion holes 114B, where the two insertion holes are in communication with the insertion space 113B. The socket body 110B is provided with two first electrode slots 115B, where the two first electrode slots 115B are formed at a bottom of the insertion space 113B and are in communication with the insertion space 113B. The socket body 110B is provided with two fixing slots 116B, where the two fixing slots 116B are spaced apart in the vertical direction on a side of the insertion space 113B.

Specifically, the cover 112B is disposed above the mounting base 111B. The insertion space 113B is formed between the mounting base 111B and the cover 112B. The two insertion holes 114B are formed in the cover 112B. The two insertion holes 114B may be in communication with the insertion space 113B. The two first electrode slots 115B and the two fixing slots 116B are both formed inside the mounting base 111B.

Specifically, the power supply electrode group 120B and the detection electrode assembly 130B are both disposed inside the mounting base 111B. The power supply electrode group 120B is disposed at a bottom of the mounting base 111B and extends out of the mounting base 111B. The detection electrode assembly 130B may be inserted into the mounting base 111B and extends out of the mounting base 111B.

The plug electrode group 30 includes at least two plug electrodes 310. Through the insertion holes 114B, the two plug electrodes 310 can be inserted into the mounting base 111B to trigger the detection electrode assembly 130B, and contact the power supply electrode group 120B.

Specifically, a mounting groove 117B in communication with the two insertion holes 114B is formed on the side of the cover 112B away from the mounting base 111B, such that when the plug electrode group 30 is accommodated in the mounting groove 117B, the plug electrodes 310 can be inserted into the insertion space 113B via the insertion holes 114B, to abut against the power supply electrode group 120B.

The insertion space 113B is configured for accommodating the power supply electrode group 120B and the detection electrode assembly 130B. The two plug electrodes 310 of the plug electrode group 30 can enter the insertion space 113B, and in the insertion space 113B, contact the power supply electrode group 120B and trigger the detection electrode assembly 130B. Specifically, a fixing plate 118B is provided in the insertion space 113B, the detection electrode assembly 130B is disposed on one side of the fixing plate 118B, and the power supply electrode group 120B is disposed on the side of the fixing plate 118B away from the detection electrode assembly 130B.

Further, the fixing plate 118B is provided with at least one communication hole 119B, and the two plug electrodes 310 of the plug electrode group 30 pass through the fixing plate 118B via the communication hole 119B and abut against the power supply electrode group 120B. The fixing plate 118B is fixedly disposed at the bottom of the insertion space 113B, and the two first electrode slots 115B and the two communication holes 119B are disposed opposite in one-to-one correspondence.

Specifically, the two first electrode slots 115B are disposed on the side of the fixing plate 118B away from the detection electrode assembly 130B, to accommodate the power supply electrode group 120B. The two plug electrodes 310 of the plug electrode group 30 can enter the two first electrode slots 115B and contact the power supply electrode group 120B via the communication holes 119B on the fixing plate 118B.

Specifically, the two fixing slots 116B are disposed on side walls of the mounting base 111B, and the two fixing slots 116B are spaced apart to accommodate some components of the detection electrode assembly 130B.

As shown in FIG. 6 to FIG. 8, the power supply electrode group 120B includes two power supply electrodes 121B. The detection electrode assembly 130B includes a movable block 131B, a movable electrode 132B, and two fixed electrodes 133B.

Specifically, the power supply electrode group 120B is disposed in the socket body 110B, enabling it to contact the plug electrode group 30 inserted into the socket body 110B. Specifically, the two plug electrodes 310 may be inserted into the socket body 110B to contact the two power supply electrodes 121B. The two power supply electrodes 121B may be connected to a live wire and a neutral line, to connect the plug electrode group 30 to the live wire and the neutral line, respectively.

The power supply electrode group 120B may further include a ground electrode 122B. The ground electrode 122B is disposed in the socket body 110B for grounding and has two electrode portions 123B. The two electrode portions 123B extend into the mounting groove 117B via the insertion space 113B, and an orientation of the two electrode portions 123B intersects with an orientation of the two insertion holes 114B. Specifically, the ground electrode 122B is spaced apart from the two power supply electrodes 121B.

Specifically, the two insertion holes 114B are disposed opposite to the two power supply electrodes 121B, and the two power supply electrodes 121B are disposed on the side of the fixing plate 118B away from the movable block 131B. The at least one communication hole 119B corresponds one to one with (e.g., respectively aligned with) and is disposed opposite to at least one power supply electrode 121B located on the side opposite to the fixing plate 118B, such that the corresponding plug electrode 310 in the plug electrode group 30 is inserted and abuts against the corresponding power supply electrode 121B. The quantity of the at least one communication hole 119B is two, the two communication holes 119B correspond one to one with the power supply electrodes 121B, and the two plug electrodes 310 pass through the fixing plate 118B via the communication holes 119B and abut against the two power supply electrodes 121B.

Specifically, the two power supply electrodes 121B are accommodated in the two first electrode slots 115B respectively and partially extend out of the socket body 110B. The portions of the two power supply electrodes 121B that extend out of the socket body 110B are connected to the inverter circuit 210 in the apparatus body 20. The inverter circuit 210 may supply power to the plug electrode group 30 through the two power supply electrodes 121B.

The detection electrode assembly 130B may be disposed in the socket body 110B, to detect whether the plug electrode group 30 is inserted to the preset position in the socket body 110B. The movable block 131B is disposed on the socket body 110B in a sliding manner. The movable electrode 132B is fixedly connected to the movable block 131B, and the two fixed electrodes 133B are disposed in the socket body 110B at interval. The movable block 131B can drive the movable electrode 132B to slide, and the movable electrode 132B can simultaneously contact the two fixed electrodes 133B or separate (e.g., disengage) from at least one fixed electrode 133B.

The two fixed electrodes 133B are disposed in the two fixing slots 116B in one-to-one correspondence, and the two fixed electrodes 133B pass through the bottom of the insertion space 113B and extend out of the socket body 110B. Further, the two fixed electrodes 133B are disposed in the two fixing slots 116B on the sides of the insertion space 113B, and are spaced apart in the vertical direction. Specifically, the two fixed electrodes 133B are electrically connected to the control circuit 220 respectively, to transmit detection signals to the control circuit 220. Specifically, the control circuit 220 is configured for, triggered by the two fixed electrodes 133B, controlling the inverter circuit 210 to supply power to the outside through the power electrode group 120B when the two fixed electrodes 133B are connected, and controlling the inverter circuit 210 to stop supplying power to the outside when the two fixed electrodes 133B are disconnected.

Specifically, the movable block 131B is spaced apart from the power supply electrodes 121B, the movable block 131B is disposed on one side of the fixing plate 118B in a sliding manner, and at least one power supply electrode 121B is disposed on the other opposite side of the fixing plate 118B. Such settings can reduce the possibilities of interference and short circuits due to contact between the power supply electrode group 120B and the detection electrode assembly 130B.

The movable block 131B is configured for abutting against the plug electrodes 310 inserted into the socket body 110B, and slides in a direction perpendicular to the insertion direction of the plug electrodes 310 with the movement of the plug electrodes 310, thereby driving the movable electrode 132B to simultaneously contact the two fixed electrodes 133B or separate (e.g., disengage) from at least one fixed electrode 133B.

Specifically, the movable block 131B has a wedge-shaped portion or section 1311 on the portion for shielding the at least one communication hole 119B, the wedge-shaped portion or section 1311 is inclined relative to the vertical direction, and the wedge-shaped portion or section 1311 is configured for abutting against the corresponding plug electrode 310, so as to slide towards the vertical direction under push by the corresponding plug electrode 310. Specifically, when the plug electrode group is not inserted into the socket body 110B, the movable block 131B shields the at least one communication hole 119B. When the plug electrode group is inserted into the socket body 110B, the plug electrodes 310 push the movable block 131B to slide towards the vertical direction through the wedge-shaped portion or section 1311, such that the movable block 131B exposes the originally shielded communication hole 119B. The plug electrodes 310 continue to push over the movable block 131B, and pass through the fixing plate 118B via the communication holes 119B. At this time, the plug electrode group 30 is in the predicted position.

Specifically, when the plug electrode group 30 is not inserted to the preset position, the movable electrode 132B separates or disengages from at least one fixed electrode 133B, to form an open circuit between the two fixed electrodes 133B; when the plug electrode group 30 is inserted to the preset position, the movable electrode 132B contacts the two fixed electrodes 133B simultaneously, to connect the two fixed electrodes 133B, for forming a current loop.

The movable electrode 132B is disposed on a side of the movable block 131B, the side being opposite to the two fixing slots 116B. The movable electrode 132B is provided with a limit portion 1321B, and the movable electrode 132B is fixedly connected to the movable block 131B by the limit portion 1321B, such that the movable electrode 132B can slide along with the sliding of the movable block 131B.

Further, a limit slot 1312B is formed on the side of the movable block 131B opposite to the two fixing slots 116B, the limit portion 1321B is movably inserted into the limit slot 1312B, a limit elastic member 1313B is provided in the limit slot 1312B, and the limit elastic member 1313B is elastically connected to the movable block 131B and the limit portion 1321B, such that the movable electrode 132B elastically abuts against the two fixed electrodes 133B. By providing the limit elastic member 1313B, the movable electrode 132B can elastically abut against the two fixed electrodes 133B under the pressure of the limit elastic member 1313B, thereby improving the tightness of the detection electrode assembly 130B, and reducing the possibility that the movable electrode 132B cannot contact the two fixed electrodes 133B when the movable block 131B moves.

The detection electrode assembly 130B includes an elastic member 134B, the elastic member 134B is disposed in the socket body 110B, and the elastic member 134B is connected to the socket body 110B and the movable block 131B. When the movable electrode 132B contacts the two fixed electrodes 133B, the elastic member 134B is in an elastic compression state. When the plug electrode group 30 is not inserted into the socket body 110B, the elastic member 134B resets the movable block 131B, such that the movable electrode 132B separates or disengages from at least one fixed electrode 133B. Specifically, one end of the elastic member is connected to the movable block 131B, and the other end is connected to the fixing plate 118B or the socket body 110B. As such, when the plug 3 is not inserted into the socket body 110B, the movable block 131B shields the communication holes 119B to shield the power supply electrodes 121B, so as to prevent water droplets or other conductive objects from falling into the socket body 110B to cause short circuits and fires.

Based on the above content, a description of the specific mating process between the socket assembly 10B and the plug 3 is provided below:

When the plug electrode group 30 is inserted into the socket body 110B, the plug electrodes 310 enter the insertion space 113B via the insertion holes 114B on the cover 112B. The plug electrodes 310 first abut against the wedge-shaped portion or section 1311 of the movable block 131B. The wedge-shaped portion or section 1311, pushed by the corresponding plug electrodes 310, slides towards the vertical direction, such that the movable block 131B slides on one side of the fixing plate 118B and compresses the elastic member 134B. The movable electrode 132B, disposed on the side of the movable block 131B, also slides with the movable block 131B. The movable block 131B exposes the communication holes 119B on the fixing plate 118B and the power supply electrodes 121B on the other side of the fixing plate 118B. The plug electrodes 310 then cross the movable block 131B, pass through the fixing plate 118B via the communication holes 119B, and reach the preset position. The movable electrode 132B contacts the two fixed electrodes 133B, the two fixed electrodes 133B being disposed in the two fixing slots 116B on the sides of the insertion space 113B. The movable electrode 132B connects the two fixed electrodes 133B, to form a current loop. At this time, the detection electrode assembly 130B is in an on state, and can generate detection signals and transmit the detection signals to the control circuit 220. The plug electrodes 310 continue to advance and contact the power supply electrodes 121B. The plug electrodes 310, located in the mounting groove 117B, contact the ground electrode 122B. At this time, the control circuit 220 controls the inverter circuit 210, and the inverter circuit 210 supplies power to the plug electrode group 30 via the power supply electrodes 121B of the power supply electrode group 120B.

When the plug electrode group 30 is pulled out of the electronic apparatus 1 described in the present application, the plug electrodes 310 separate from the power supply electrodes 121B, then leave the fixing plate 118B via the communication holes 119B, and separate from the movable block 131B. The elastic member 134B recovers from the elastic compression state, and resets the movable block 131B to re-shield the communication holes 119B and the power supply electrodes 121B. The movable block 131B drives the movable electrode 132B to separate or disengage from at least one fixed electrode 133B. At this time, the current loop is disconnected, and the detection electrode assembly 130B is in an off state and cannot transmit detection signals to the control circuit 220, such that the control circuit 220 controls the inverter circuit 210 to stop supplying power to the plug electrode group 30.

In summary, as an example, the power supply electrode group 120A (120B) and the detection electrode assembly 130A (130B) are provided on the socket assembly 10, where the detection electrode assembly 130A (130B) detects the insertion state of the plug electrode group 30. When the plug electrode group 30 is inserted to the preset position and contacts the power supply electrode group 120A (120B), the detection electrode assembly 130A (130B) is in an on state, which can form a current loop and then generate a detection signal. The detection signal can be provided to the control circuit 220, and the control circuit 220 controls the inverter circuit 210 to supply power to the outside through the power supply electrode group 120A (120B). As such, the phenomenon of sparking at the moment of insertion of a plug can be effectively solved, and safety hazards of a socket during use can be reduced. Meanwhile, when the plug electrode group 30 is not inserted to the preset position, the detection electrode assembly 130A (130B) is in an off state without forming a current loop or generating a detection signal, and the control circuit 220 controls the inverter circuit 210 to stop supplying power to the outside, which can solve the problem that the standby socket still supplies power, reduce unnecessary power consumption, and effectively save energy.

Described above are only the examples of the present application, and the patent scope of the patent application is not limited thereto. Any equivalent structure or equivalent process transformation made using the description and accompanying drawings of the present application, directly or indirectly applied in other related technical fields, is also included in the scope of patent protection of the present application.

What is claimed is:

1. A socket assembly, comprising:
a socket body;
a power supply electrode group disposed in the socket body, wherein the power supply electrode group contacts a plug electrode group when the plug electrode group is inserted to a preset position in the socket body; and
a detection electrode assembly, disposed in the socket body and configured to detect an insertion state of the plug electrode group, wherein the detection electrode assembly has an off state and an on state; and wherein:
when the plug electrode group is not inserted to the preset position, the detection electrode assembly is in the off state; or
when the plug electrode group is inserted to the preset position, the detection electrode assembly is in the on state to form a current loop and to generate a detection signal to be transmitted among the detection electrode assembly.

2. The socket assembly according to claim 1, wherein:
the detection electrode assembly comprises a movable electrode and two fixed electrodes, the movable electrode is movably disposed in the socket body, and the two fixed electrodes are spaced apart on the socket body; and wherein:
the movable electrode separates from the two fixed electrodes when the plug electrode group is not inserted to the preset position, such that the detection electrode assembly is in the off state; or
the movable electrode contacts the two fixed electrodes and connects the two fixed electrodes when the plug electrode group is inserted to the preset position, such that the detection electrode assembly is in the on state.

3. The socket assembly according to claim 2, wherein:
the detection electrode assembly comprises a movable block fixedly connected to the movable electrode, the movable block is movably disposed in the socket body and configured to abut against the plug electrode group when the plug electrode group is inserted into the socket body, and the plug electrode group drives a movement of the movable block, such that the movable electrode contacts the two fixed electrodes when the plug electrode group is inserted to the preset position.

4. The socket assembly according to claim 3, wherein:
the detection electrode assembly comprises an elastic member comprising a spring disposed in the socket body, and the elastic member connects the socket body to the movable block, allowing the elastic member to be in an elastic compression state when the movable electrode contacts the two fixed electrodes, and the elastic member resets the movable block when the plug electrode group is not inserted into the socket body, such that the movable electrode disengages from the two fixed electrodes.

5. The socket assembly according to claim 4, wherein:
the power supply electrode group comprises two power supply electrodes, the socket body is provided with an insertion space and two insertion holes, the two insertion holes are in communication with the insertion space, the two power supply electrodes extend from an exterior of the socket body into the insertion space, and the two power supply electrodes are arranged to align one-to-one with the two insertion holes; the two fixed electrodes extend from the exterior of the socket body into the insertion space, the movable block is disposed in the insertion space in a sliding manner, and the elastic member is disposed in the insertion space; and
the two fixed electrodes are disposed opposite each other, the two power supply electrodes are disposed opposite each other, and an alignment direction of the two fixed electrodes is perpendicular to an alignment direction of the power supply electrodes.

6. The socket assembly according to claim 5, wherein:
the insertion space comprises two first insertion chambers, a second insertion chamber, and a sliding hole that connects the two first insertion chambers to the second insertion chamber; the two first insertion chambers are respectively aligned and in communication with the two insertion holes; each of the two power supply electrodes extends into the corresponding first insertion chamber; the movable block is disposed in the second insertion chamber in a sliding manner, and the two fixed electrodes are disposed in the second insertion chamber; and
a portion of the movable block extends through the sliding hole into the first insertion chambers, allowing the portion of the movable block to abut against two plug electrodes when the two plug electrodes of the plug electrode group are inserted into the two first insertion chambers.

7. The socket assembly according to claim 6, wherein:
an extension direction of the sliding hole is aligned with an insertion direction of the first insertion chambers, and the two plug electrodes are inserted into or removed from the two first insertion chambers along the insertion direction.

8. The socket assembly according to claim 5, wherein:
the socket body comprises a mounting base and a bottom plate, and the insertion holes and the insertion space are formed on the mounting base, the insertion holes are located at a top of the mounting base, the bottom plate is disposed at a bottom of the mounting base away from the insertion holes, the two fixed electrodes are fixedly inserted into the bottom plate and extend into the insertion space respectively, and the two power supply electrodes pass through the bottom of the mounting base and extend into the insertion space; and the elastic member is elastically connected between the movable block and the bottom plate.

9. The socket assembly according to claim 5, wherein:
the socket body is further provided with a spacing chamber and a communication hole, the spacing chamber is spaced apart from the insertion space, and the communication hole is in communication with the spacing chamber; the spacing chamber is in communication with the insertion holes, and the spacing chamber is in communication with the insertion space via the communication hole; and
the socket assembly comprises a protective door, the protective door is movably disposed in the spacing chamber, and the protective door is configured to move between a first position and a second position, shielding the communication hole when the protective door is in the first position, and exposing the communication hole when the protective door is in the second position.

10. The socket assembly according to claim 1, wherein:
the detection electrode assembly is configured to detect whether the plug electrode group is inserted to the preset position in the socket body; the detection electrode assembly comprises a movable block, a movable electrode, and two fixed electrodes; the movable block is disposed in the socket body in a sliding manner; the movable electrode is fixedly connected to the movable block, and the two fixed electrodes are spaced apart in the socket body;
and wherein the movable block is configured to abut against the plug electrode group inserted into the socket body, and the movable block slides in a direction perpendicular to an insertion direction of the plug electrode group with a movement of the plug electrode group, thereby driving the movable electrode to contact the two fixed electrodes simultaneously or separate from at least one of the fixed electrodes; when the plug electrode group is not inserted to the preset position, the movable electrode separates from at least one of the fixed electrodes, to form an open circuit between the two fixed electrodes; when the plug electrode group is inserted to the preset position, the movable electrode contacts the two fixed electrodes simultaneously and connects the two fixed electrodes, to form the current loop.

11. The socket assembly according to claim 10, wherein:
the detection electrode assembly comprises an elastic member comprising a spring, the elastic member is disposed in the socket body, and the elastic member connects the socket body to the movable block, allowing the elastic member to be in an elastic compression state when the movable electrode contacts the two fixed electrodes, and the elastic member resets the movable block when the plug electrode group is not inserted into the socket body, such that the movable electrode separates from at least one of the fixed electrodes.

12. The socket assembly according to claim 11, wherein:
the power supply electrode group comprises two power supply electrodes, the socket body is provided with an insertion space and two insertion holes, the two insertion holes are in communication with the insertion space, and the two insertion holes are disposed opposite to the two power supply electrodes; a fixing plate is provided in the insertion space, the movable block is disposed on one side of the fixing plate in a sliding manner, and at least one of the power supply electrodes is disposed on an other opposite side of the fixing plate; the fixing plate is provided with at least one communication hole, and the at least one communication hole respectively aligned with and is disposed opposite to the at least one of the power supply electrodes on the other opposite side of the fixing plate, such that the corresponding plug electrode in the plug electrode group is inserted and abuts against the corresponding power supply electrode; one end of the elastic member is connected to the movable block, and an other end is connected to the fixing plate or the socket body; when the plug electrode group is not inserted into the socket body, the movable block shields the at least one communication hole.

13. The socket assembly according to claim 12, wherein:
the movable block has a wedge-shaped section for shielding at least a portion of the at least one communication hole, the wedge-shaped section is inclined relative to a vertical direction, and the wedge-shaped section is configured to abut against the corresponding plug electrode, allowing the wedge-shaped section to slide towards the vertical direction under a push by the corresponding plug electrode.

14. The socket assembly according to claim 12, wherein:
the two power supply electrodes are disposed on the side of the fixing plate away from the movable block, and a quantity of the at least one communication hole is two; the socket body is provided with two first electrode slots, wherein two first electrode slots are located at a bottom of the insertion space and are in communication with the insertion space; the fixing plate is fixedly disposed at the bottom of the insertion space, the two first electrode slots and the two communication holes are aligned in a one-to-one and opposite arrangement, and each of the two power supply electrodes is accommodated in its corresponding first electrode slot and partially extend outside of the socket body.

15. The socket assembly according to claim 12, wherein:
the socket body is provided with two fixing slots spaced apart in the vertical direction on a side of the insertion space, the two fixed electrodes are respectively disposed in the two fixing slots, and the two fixed electrodes pass through a bottom of the insertion space and extend outside of the socket body; and the movable electrode is disposed on the side of the movable block opposite to the two fixing slots.

16. The socket assembly according to claim 15, wherein:
a limit slot is formed on the side of the movable block opposite to the two fixing slots, the movable electrode is provided with a limit portion that is movably inserted into the limit slot, a limit elastic member is provided in the limit slot, and the limit elastic member is elastically connected to the movable block and the limit portion, such that the movable electrode elastically abuts against the two fixed electrodes.

17. The socket assembly according to claim 12, wherein:
the socket body comprises a mounting base and a cover, the insertion space is formed between the mounting base and the cover, the two insertion holes are formed in the cover, and a mounting groove in communication with the two insertion holes is located on the side of the cover away from the mounting base, such that when the plug electrode group is accommodated in the mounting groove, the plug electrode group is inserted into the insertion space via the insertion holes, to abut against the power supply electrode group.

18. The socket assembly according to claim 17, wherein:
the power supply electrode group further comprises a ground electrode disposed in the socket body and configured to ground the power supply electrode group;
the ground electrode has two electrode portions; and
the two electrode portions extend into the mounting groove via the insertion space, and the orientation of the two electrode portions intersects the orientation of the two insertion holes.

19. An electronic apparatus, comprising:
an apparatus body, comprising an inverter circuit and a control circuit, wherein the control circuit is electrically connected to the inverter circuit, and the inverter circuit is configured for being connected to a power source; and
a socket assembly disposed in the apparatus body, wherein the socket assembly comprises:
a socket body;
a power supply electrode group disposed in the socket body, wherein the power supply electrode group contacts a plug electrode group when the plug electrode group is further inserted to a preset position in the socket body; and
a detection electrode assembly, disposed in the socket body and configured for detecting an insertion state of the plug electrode group, wherein the detection electrode assembly has an off state and an on state; and wherein:
when the plug electrode group is not inserted to the preset position, the detection electrode assembly is in the off state; or
when the plug electrode group is inserted to the preset position, the detection electrode assembly is in the on state to form a current loop and to generate a detection signal to be transmitted among the detection electrode assembly;
wherein the power supply electrode group is electrically connected to the inverter circuit; the detection electrode assembly is electrically connected to the control circuit;
wherein, when triggered by the detection electrode assembly, the control circuit is configured to:
control the inverter circuit to supply power to an external environment through the power supply electrode group when the detection electrode assembly is in the on state; or
control the inverter circuit to stop supplying power to the external environment when the detection electrode assembly is in the off state.

20. A control circuit coupled to an inverter circuit and a socket assembly,
wherein the socket assembly comprises:
a socket body;
a power supply electrode group disposed in the socket body, wherein the power supply electrode group contacts a plug electrode group when the plug electrode group is further inserted to a preset position in the socket body; and
a detection electrode assembly, disposed in the socket body and configured for detecting an insertion state of the plug electrode group, wherein the detection electrode assembly has an off state and an on state; and wherein:
when the plug electrode group is not inserted to the preset position, the detection electrode assembly is in the off state; or
when the plug electrode group is inserted to the preset position, the detection electrode assembly is in the on state to form a current loop and to generate a detection signal to be transmitted among the detection electrode assembly;
and wherein, when triggered by the detection electrode assembly of the socket assembly, the control circuit is configured to:
control the inverter circuit to supply power to an external environment through the power supply electrode group when the detection electrode assembly is in the on state; or
control the inverter circuit to stop supplying power to the external environment when the detection electrode assembly is in the off state.
